(19) United States
(12) Patent Application Publication
(10) Pub. No.: US 2023/0237821 A1
(43) Pub. Date: Jul. 27, 2023

(54) METHOD AND APPARATUS FOR RECOGNIZING THREE DIMENSIONAL OBJECT BASED ON DEEP LEARNING

(71) Applicant: ELECTRONICS AND TELECOMMUNICATIONS RESEARCH INSTITUTE, Daejeon (KR)

(72) Inventor: Eun Ju JEONG, Daejeon (KR)

(21) Appl. No.: 18/099,447

(22) Filed: Jan. 20, 2023

(30) Foreign Application Priority Data
Jan. 26, 2022 (KR) 10-2022-0011660

(51) Int. Cl. G06V 20/70; G06V 10/774; G06V 20/64

(52) U.S. Cl. CPC G06V 20/70; G06V 10/774; G06V 20/64

(57) ABSTRACT

A method and apparatus for recognizing a three-dimensional (3D) object based on deep learning are provided. An object recognition apparatus constructs a data set including a virtual image and a real image, in which the data set includes labeled data corresponding to the virtual image and the real image, and unlabeled data corresponding to the virtual image and the real image. The object recognition apparatus inputs the data set to a recognition model for pre-trained object recognition based on self-supervised learning to perform the object recognition and acquire object information according to the object recognition.

### CROSS-REFERENCE TO RELATED APPLICATION

This application claims priority to and the benefit of Korean Patent Application No. 10-2022-0011660, filed on Jan. 26, 2022, the disclosure of which is incorporated herein by reference in its entirety.

### BACKGROUND

### 1. Field of the Invention

The present disclosure relates to object recognition, and more particularly, to a method and apparatus for recognizing a three dimensional object based on deep learning.

### 2. Description of Related Art

Research on manipulating three dimensional (3D) objects using robots is being actively conducted from virtual simulations to real environments. In particular, research on deep learning-based image analysis is being conducted so that automatic robots in manufacturing factories may grip deformable objects. These deep learning-based vision systems process new applications, from inspecting surface defects to inspecting an assembly of various parts and reading challenging text, thereby providing factory automation opportunities in various industries.

However, the use of machine learning in the deep learning-based vision systems always requires very large and complex data sets, which are costly to collect.

In addition, since the machine learning is performed after a person manually assigns labels to data, considerable human labor is required to prepare data for learning, and related costs increase.

### SUMMARY OF THE INVENTION

The present disclosure is directed to providing a method and apparatus capable of efficiently and accurately recognizing a three-dimensional (3D) object using self-supervised learning.

According to an embodiment, there is provided a method of recognizing a 3D object. The method may include constructing, by an object recognition apparatus, a data set including a virtual image and a real image, the data set including labeled data corresponding to the virtual image and the real image, and unlabeled data corresponding to the virtual image and the real image; inputting, by the object recognition device, the data set to a recognition model for object recognition pre-trained based on self-supervised learning to perform the object recognition; and acquiring, by the object recognition apparatus, object information according to the object recognition using the recognition model.

The data set may include a plurality of sets, in which each set may include a first set number of pieces of labeled data composed of a set number of frames, and a second set number of pieces of unlabeled data composed of the set number of frames.

The first set number may be “1,” and the second set number may be an integer greater than or equal to 2.

The object information may include six degrees of freedom (6DoF) of the object, and may further include at least one of a distance to a center point and shape information.

The constructing of the data set may include: performing outlier detection on data included in the data set; and constructing the data set by selecting data for which a result of the outlier detection satisfies a set condition from among data included in the data set.

In the performing of the outlier detection, the outlier detection may be performed on the unlabeled data in the data set. In the constructing of the data set by selecting only data for which the result of the outlier detection satisfies the set condition from among the unlabeled data may be selected as data for performing the object recognition.

In the performing of the object recognition, the object recognition may be performed by querying labeling of the data included in the data set in units of frames.

According to another aspect of the present invention, there is provided a method of recognizing a 3D object, including: constructing, by an object recognition apparatus, a data set including a virtual image and a real image, the data set including labeled data corresponding to the virtual image and the real image, and unlabeled data corresponding to the virtual image and the real image; and training, by the object recognition apparatus, a recognition model for object recognition using self-supervised learning based on the data set.

The data set may include a plurality of sets, in which each set may include a first set number of pieces of labeled data composed of a set number of frames, and a second set number of pieces of unlabeled data composed of the set number of frames.

The first set number may be “1,” and the second set number may be an integer greater than or equal to 2.

The constructing of the data set may include: performing outlier detection on data included in the data set; and constructing the data set by selecting data for which a result of the outlier detection satisfies a set condition from among data included in the data set.

In the constructing of the data set, a higher priority may be given to unlabeled data, in which a difference between a result of performing inference without performing the outlier detection and a result of performing the inference after performing the outlier detection is greater than a set value, over other pieces of data, and the unlabeled data may be included in the data set.

According to still another aspect of the present invention, there is provided an apparatus for recognizing a 3D object, including: an interface device; and a processor connected to the interface device to perform object recognition, in which the processor may include: a data set processing unit configured to construct a data set including the virtual image and the real image, the data set including labeled data corresponding to a virtual image and a real image, and unlabeled data corresponding to the virtual image and the real image; and an object recognition processing unit configured to input the data set to a recognition model for pre-trained object recognition based on self-supervised learning to perform the object recognition and acquire object information.

The data set may include a plurality of sets, in which each set may include a first set number of pieces of labeled data composed of a set number of frames, and a second set number of pieces of unlabeled data composed of the set number of frames.

The first set number may be “1,” and the second set number may be an integer greater than or equal to 2.

The object information may include 6DoF of the object, and may further include at least one of a distance to a center point and shape information.

The data set processing unit may be configured to perform the outlier detection on unlabeled data in the data set, and select only data for which the result of the outlier detection satisfies a set condition from among the unlabeled data and select the selected data as data for performing object recognition.

The data set processing unit may be configured to perform the outlier detection on the unlabeled data in the data set, and select only data for which the result of the outlier detection satisfies a set condition from among the unlabeled data and select the selected data as data for performing the object recognition.

The processor may further include a training processing unit configured to train the recognition model for the object recognition using self-supervised learning based on the data set.

The training processing unit may give a higher priority to unlabeled data in which a difference between a result of performing inference without performing the outlier detection and a result of performing the inference after performing the outlier detection is greater than a set value, over other pieces of data, and include the unlabeled data in the data set.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram of a method of recognizing a three-dimensional (3D) object based on deep learning according to an embodiment of the present disclosure;

FIGS. 2A-2D show exemplary diagrams illustrating image data according to an embodiment of the present disclosure;

FIG. 3 is an exemplary diagram illustrating 3D information according to an embodiment of the present disclosure;

FIG. 4 is an exemplary diagram illustrating a method of generating image data according to an embodiment of the present disclosure;

FIGS. 5A and 5B show exemplary diagrams illustrating a method of constructing a data set in units of frames according to an embodiment of the present disclosure;

FIG. 6 is a conceptual diagram illustrating a process of acquiring object information according to inference according to an embodiment of the present disclosure;

FIG. 7 is a flowchart of a learning method for 3D object recognition according to an embodiment of the present disclosure;

FIG. 8 is a flowchart of a method of recognizing a 3D object according to an embodiment of the present disclosure;

FIG. 9 is a diagram illustrating a structure of an apparatus for recognizing a 3D object based on deep learning according to an embodiment of the present disclosure; and

FIG. 10 is a structural diagram for describing a computing device for implementing the method according to the embodiment of the present disclosure.

### DETAILED DESCRIPTION OF EXEMPLARY EMBODIMENTS

Hereinafter, embodiments of the present disclosure will be described in detail with reference to the accompanying drawings so that those skilled in the art to which the present disclosure pertains may easily practice the present disclosure. However, the present disclosure may be modified in various different ways, and is not limited to embodiments described herein. In addition, in the drawings, portions unrelated to the description will be omitted to clearly describe the disclosure, and like reference numerals will be used to describe like parts throughout the specification.

Throughout the present specification, unless explicitly described to the contrary, “comprising” certain components will be understood to imply the inclusion of other elements rather than the exclusion of other elements.

In this specification, an expression written in the singular may be construed as singular or plural unless an explicit expression such as “one” or “single” is used.

Terms including an ordinal number such as first, second, or the like, used in embodiments of the present disclosure may be used to describe various components. However, these components are not limited to these terms. Terms are used only in order to distinguish one component from another component. For example, the “first” component may be named the “second” component, and vice versa, without departing from the scope of the present disclosure.

Hereinafter, a method and apparatus for recognizing a three-dimensional (3D) object based on deep learning according to embodiments of the present disclosure will be described with reference to the accompanying drawings.

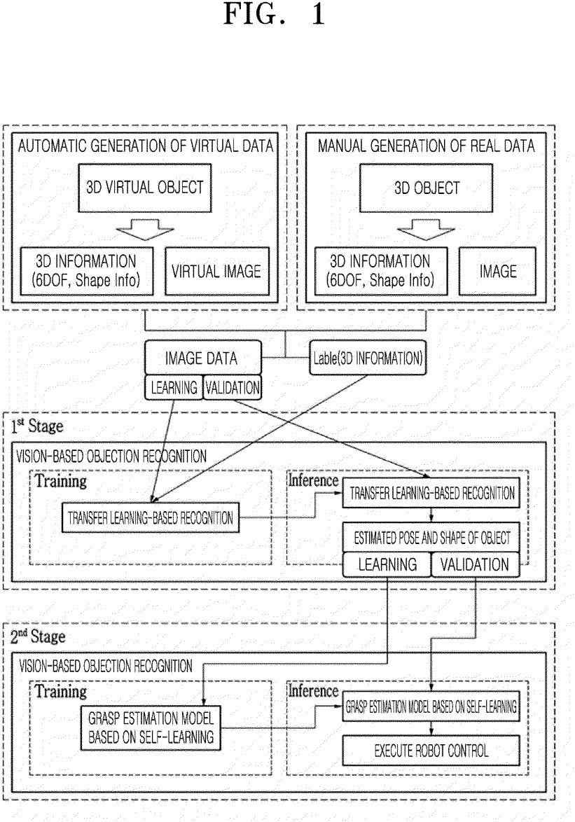

FIG. 1 is a conceptual diagram of a method of recognizing a 3D object based on deep learning according to an embodiment of the present disclosure.

In an embodiment of the present disclosure, a 3D object is recognized using a self-supervised learning model. For this purpose, virtual environment data and real environment data are synthesized and processed.

As illustrated in FIG. 1, a data set for self-supervised learning is generated. Synthetic data, that is, virtual data which is virtual environment data including virtual images and 3D information of 3D virtual objects in a virtual environment, may be generated, and the virtual data may be automatically generated. In addition, the real environment data including the images and 3D information of the 3D objects in the real environment, that is, real data, is generated. Such real data generation may be manually performed. Here, the 3D information on the virtual data and the real data includes six degrees of freedom (6DoF) information and shape information (e.g., meshes and bounding boxes).

A data set including the virtual data and real data generated in this way is formed, and the data set includes the image data and the 3D information. Here, the 3D information may be used as a label.

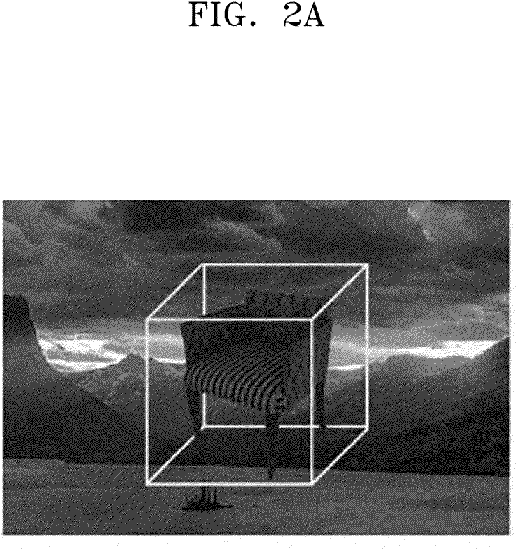

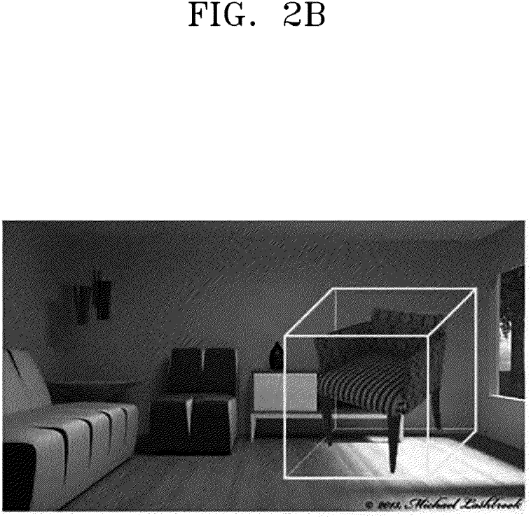

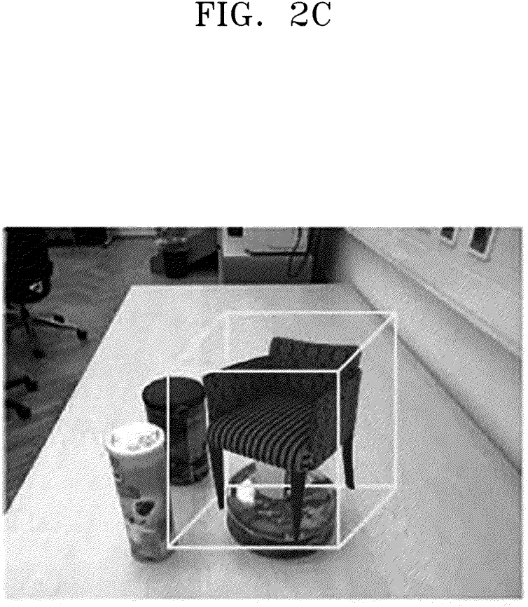

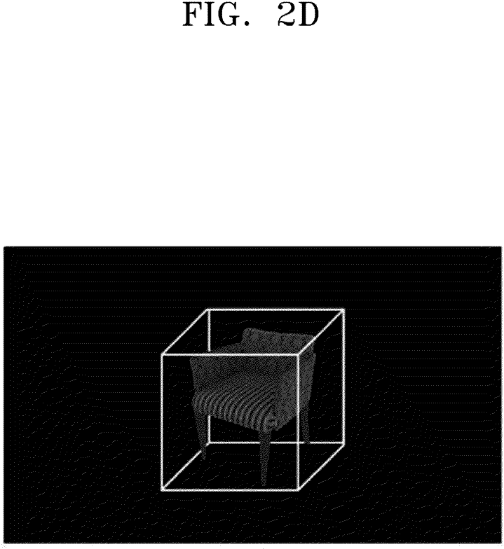

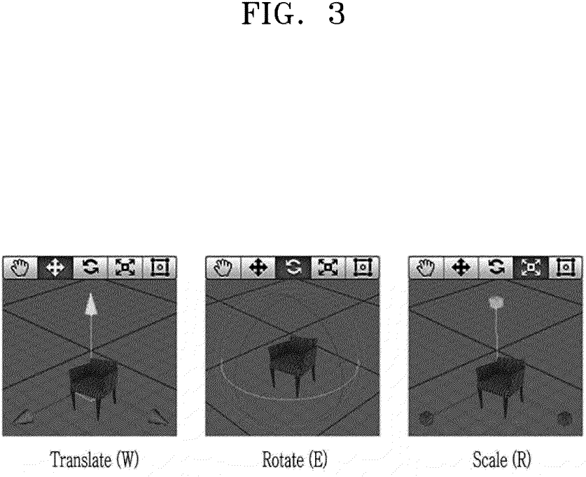

FIGS. 2A-2D show exemplary diagrams illustrating image data according to an embodiment of the present disclosure, and FIG. 3 is an exemplary diagram illustrating 3D information according to an embodiment of the present disclosure.

The image data is an image of a 3D object. As illustrated in FIGS. 2A and 2B, it is possible to build a 3D virtual environment and generate a 3D virtual object to generate and collect virtual images of the virtual object, and also as illustrated in FIGS. 2C and 2D, the images of the 3D object in the real environment may be collected. For example, an image of an object may be acquired by purchasing an actual product and placing the purchased product in any of various locations, changing lighting and background conditions while taking several pictures of the purchased product, and changing the location and orientation or composition of the object.

For this image data, shape information such as a bounding box (or a mesh) is acquired, and as illustrated in FIG. 3, 6DoF and scale are acquired. The 6DoF includes position-related 3DoF of X, Y, and Z, and the remainder as rotation and translation.

The 3D information included in the data set includes the shape, the 6DoF, and the scale, but is not necessarily limited thereto.

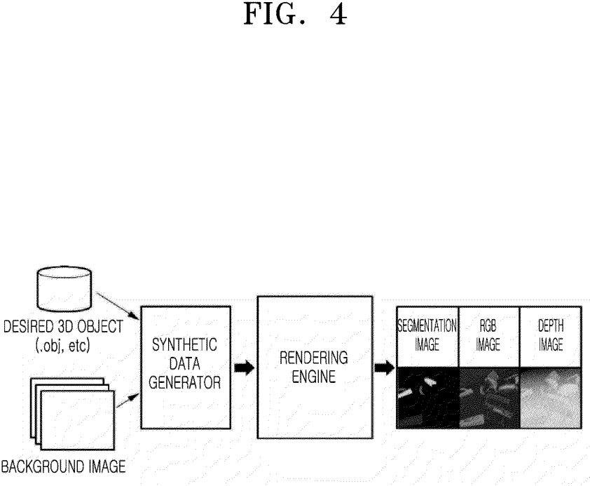

FIG. 4 is an exemplary diagram illustrating a method of generating image data according to an embodiment of the present disclosure.

For example, as illustrated in FIG. 4, by inputting an image of a 3D object and a plurality of preset background images to a Python-based computer vision and deep learning unit (synthetic data generator, e.g. BPYCV), a position, a rotation angle, and the like of the 3D object are randomly set to output a large number of images. Such a large number of images are synthesized by a rendering engine. The images output by the rendering engine include a segmentation image, a red/green/blue (RGB) image, and a depth image. As a result, it is possible to customize the image in the desired shape based on Python.

The data set including the image data and 3D information acquired as described above may be used as training/validation/test data.

As illustrated in FIG. 1, self-supervised learning is performed based on the data set. In one implementation, as illustrated in FIG. 1, the data set is used to train a transfer learning-based recognition model. Here, a data pipeline may be built for the data set, and the transfer learning-based recognition model may be trained based on the data pipeline (training). Thereafter, an optimal performance model may be selected for the trained recognition model, and validation may be performed to prevent overfitting. To measure the performance of the recognition model, a test may be performed on the recognition model (inference).

In particular, in an embodiment of the present disclosure, it is possible to determine whether a label is requested in units of frames of video data in order to train a model that robustly operates on video data in various environments. That is, the label may be queried in units of frames.

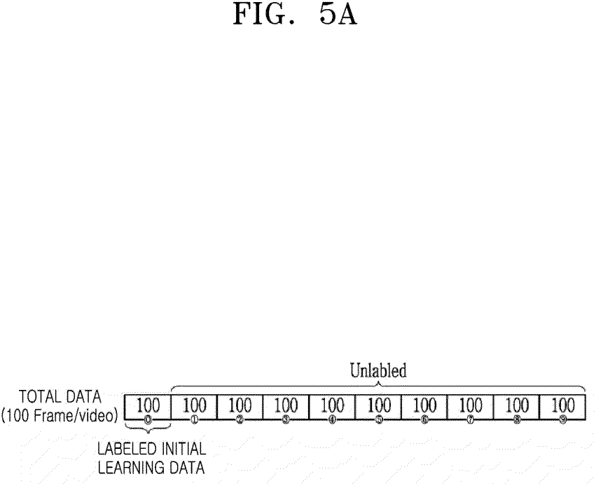

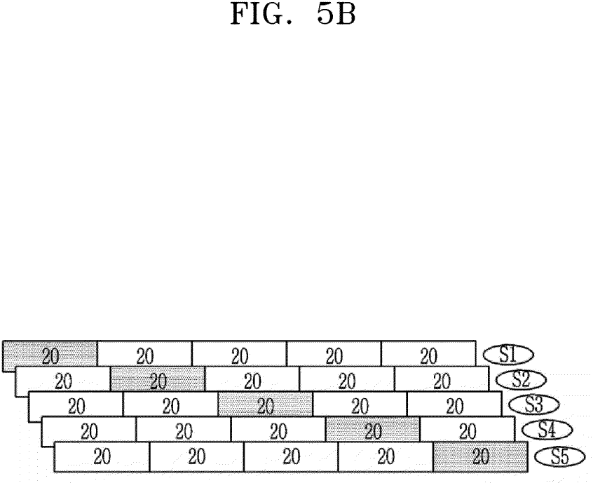

FIGS. 5A and 5B show exemplary diagrams illustrating a method of constructing a data set in units of frames according to an embodiment of the present disclosure.

In an embodiment of the present disclosure, in order to utilize unlabeled data and a small amount of data, a data set including labeled data (e.g., initially learned and labeled data) and unlabeled data is constructed. In this case, the data set may be constructed in units of frames.

Specifically, as illustrated in FIG. 5A, total data includes the labeled data and the unlabeled data. For example, labeled data composed of 100 frames is used, and unlabeled data composed of 100 frames is used in large numbers. That is, one piece of labeled data (⓪) and nine pieces of unlabeled data (① to ⑨⑨) are used.

Then, each of the labeled data and unlabeled data is divided into a plurality of sets by the set number of frames (e.g., 20 frames). For example, as illustrated in FIG. 5B, a data set including 20 frames of labeled data (⓪), 20 frames of unlabeled data (①), 20 frames of the unlabeled data (②), 20 frames of unlabeled data (③), 20 frames of unlabeled data (④), and the like is set as a first set S 1. Then, a data set including 20 frames of the remaining frames of the labeled data (⓪), 20 frames of the remaining frames of the unlabeled data (①), 20 frames of the remaining frames of the unlabeled data (②), and 20 frames of the remaining frames of the unlabeled data (③), 20 frames of the remaining frames of the unlabeled data (④), and the like is set as a second set S2. In this way, labeled data and a plurality of pieces of unlabeled data, each of which is composed of 100 frames, are divided into 20 pieces to form five sets S1 to S5. Accordingly, each set include the labeled data and a plurality of pieces of unlabeled data. Here, for convenience of explanation, it is described that the unlabeled data ① to ④ is used, but unlabeled data ⑤ to ⑨ may also be equally included in each of the set S1 to S5 at 20 frames.

In this way, the data set (e.g., S1 to S5) may be configured using one piece of labeled data composed of the set number of frames and a plurality of pieces of unlabeled data composed of the set number of frames. These data sets may be used for training and validation, and the label may be queried in units of frames for each set during training and validation. Here, as an implementation example, four sets (e.g., S1 to S4) among the sets S1 to S5 may be used for model training, and one set (e.g., S5) may be used for validation.

As additional description, when the data set is implemented so that the query can be performed in units of frames, domain adaptation may be performed so that the model trained in synthesis may be used in the real environment. Since it is relatively difficult to secure the label data in the real environment compared to the virtual environment, in order to obtain a model that may be used in the real environment with few or no labels, it may be necessary to use (semi-) self-supervised learning.

To this end, in stage 1, the model learning is performed using the virtual environment data. In stage 2, a rotation/translation network among sub-networks of a 6Dof algorithm is frozen and not learned, and the detection part (class/box network) is trained with the real environment data using the self-supervised learning. In stage 3, model fine-tuning is performed using a small number of pieces of the real environment label data.

Thereafter, a video set requiring labeling is selected from the real data set (selection and query process), and videos included in the selected video set are labeled (labeling process). In this case, the process of selecting and querying the real data set may be implemented, but in the labeling process, there is an issue in that the labeling needs to be performed directly by a user.

An amount of raw data (e.g., read video) is very large and an amount of the labeling data among the raw data is small. For efficient learning using a small amount of labeled data, pseudo-labeling inferred by the pre-trained model is generated for the unlabeled source data (numerous videos) without performing tuning with only the labeled data set (e.g., paired data set (video-6DOF)) using the trained model, and “additional pre-learning” may be performed based on the generated pseudo-labeling and then the tuning may be performed based on the results.

Meanwhile, it is also possible to select which video data to perform learning with evaluating unlabeled data with a recognition model trained through training. For example, a distance from a center point of a 3D object acquired by the trained recognition model or 6DoF may be used as evaluation values. In this case, the evaluation values may be accumulated for each frame, and video data composed of frames having accumulated evaluation values greater than or equal to the set value may be selected as data for learning.

In addition, in the embodiment of the present disclosure, in the case of video data, video data having a large number of outliers, of which the number of outlier samples greater than or equal to the set number, may be used. By selecting such video data, a data set may be constructed and labeling may be requested. In this case, outlier detection may be performed on the video data. For example, the outlier detection may be performed using a moving average, RANdom SAmple Consensus (RANSAC), an extended Kalman filter (EKF), etc. As an example, a prediction output may generally be processed into a signal that is processed by a filtering algorithm using a low pass filter or a moving average. However, a prediction result has less noise than the normal signal but includes a large outlier value. To solve this problem, RANSAC and the EKF may be used in combination. Since the EKF is used to remove quaternion noise similar to smoothing, and RANSAC is used to detect the outlier value in the video data, to improve performance, the outlier value detection should be performed before smoothing. This is because significant outliers disturb the corresponding output result during smoothing. Unlike other least squares methods, in the case of position determination and outlier detection, RANSAC estimates the negative impact of outlier values on the randomly used data and the optimized solutions for the selected samples and fitting parameters from the entire sample. Apart from the rotation about the x, y, and z axes of the previous and current frame, the velocity and angular velocity can be used to remove the outlier values in order to track the motions of the camera and object.

In addition, when the inference is performed using the trained recognition model, that is, when labeling is requested, the inference may be performed using all the unlabeled data of video as the data set. Alternatively, outlier detection may be performed on the unlabeled data of the video, and the unlabeled data whose outlier detection result satisfies a set condition may be selected and used as the data set to perform the inference. Alternatively, data to request a label may be selected based on two types of data (a result of inferring the data on which the outlier detection is performed and a result of inferring the data on which the outlier detection is not performed) acquired after the inference. For example, by giving a higher priority to the unlabeled data, in which the difference between the result of performing inference without performing outlier detection on the unlabeled data of the video and the result of performing inference after performing outlier detection is greater than or equal to the set value, over other pieces of data (e.g., other pieces of unlabeled data), the unlabeled data may be selected as the data to request labeling.

Meanwhile, when testing the recognition model, as an implementation example, a holdout test set may be used. For example, Linemod, an YCB video set, or the like may be used for pose estimation of a 6DoF object to measure the performance of the model. In testing, an accuracy-threshold for an intersection over union (IoU) between a predicted bounding box and a ground truth bounding box may be used to determine whether the prediction is true or false. For example, for accuracy of pose estimation of a 3D object, a LineMod data set may be used and an average distance (ADD) value may be acquired. The performance according to accuracy may be evaluated according to an area under the ROC curve (AUC) value of the accuracy-threshold for the ADD value between each 3D point of the 3D object and the estimated 3D point.

As described above, the recognition model for inference is acquired by performing training and validation on the recognition model using a data set (first stage).

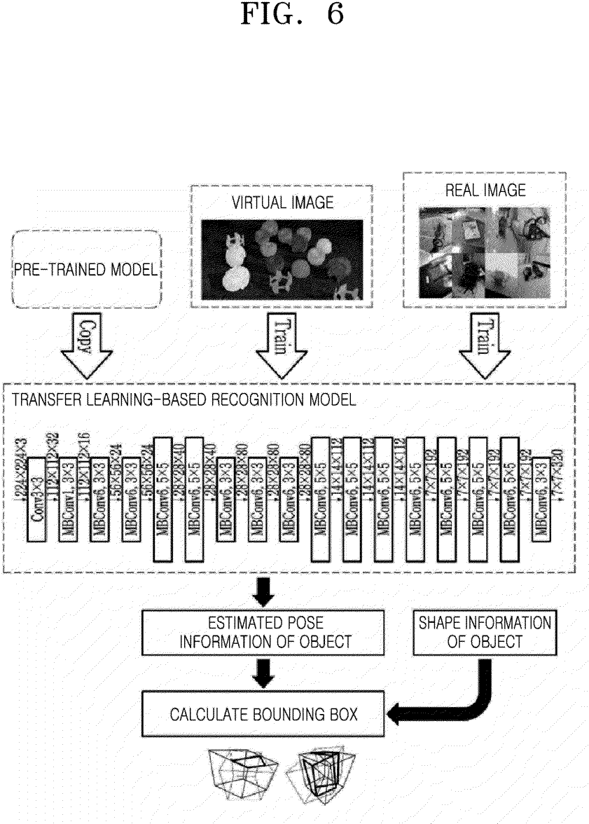

FIG. 6 is a conceptual diagram illustrating a process of acquiring object information according to inference according to an embodiment of the present disclosure.

The inference is performed based on a pre-trained recognition model and a data set composed of virtual and real images. That is, the pre-trained transfer learning-based recognition model performs labeling on the data set composed of the virtual images and real images to recognize a 3D object, and acquires object information including pose information (6DoF) for the recognized 3D object and the shape information of the object. Here, the object information may further include a distance to the center point.

Thereafter, as illustrated in FIG. 1, by practically applying the trained and validated recognition model to robot-based control (second stage), for example, the trained and validated recognition model is used as a recognition model (self-supervised learning-based grasp estimation model) for manipulation, 3D object recognition may be performed on the input image data, and robot-based control may be performed based on the 3D object recognition.

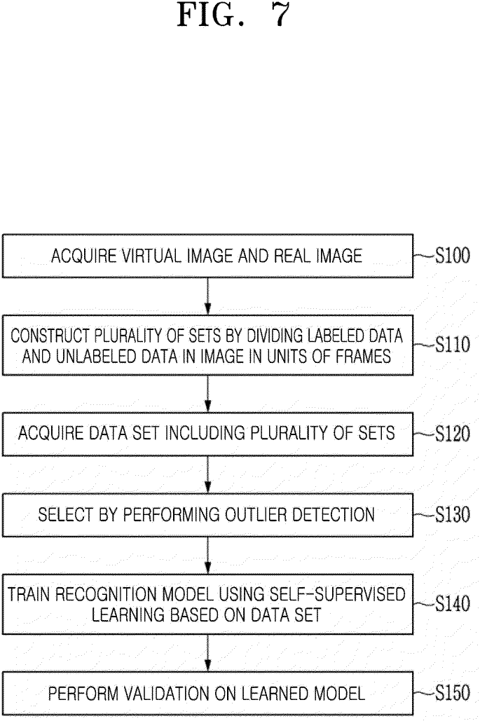

FIG. 7 is a flowchart of a learning method for 3D object recognition according to an embodiment of the present disclosure.

As illustrated in FIG. 7, a data set is created to perform training of a recognition model for object recognition. Specifically, a virtual image that is video data is acquired, and a real image is acquired (S100). Then, a data set including the virtual image and the real image is formed. The virtual image and the real image may be labeled data or unlabeled data.

In an embodiment of the present disclosure, self-supervised learning is performed after constructing a data set using only a small number of pieces of labeled data. To this end, a plurality of sets are formed by dividing labeled data (including the virtual image and the real image) and unlabeled data (including the virtual image and the real image) into a set number of frames (S110). Each set includes a first set number of pieces of labeled data composed of a set number of frames, and a second set number of pieces of unlabeled data composed of the set number of frames. Here, the first set number may be “1,” and the second set number may be an integer greater than or equal to 2. A data set including the sets is constructed (S120).

Here, by performing outlier detection on the data set, it is possible to select video data whose outlier detection result satisfies a set condition (S130). For example, by performing the outlier detection on the labeled data and/or unlabeled data of the data set, it is possible to select data having many outliers.

Next, the recognition model is trained based on the self-supervised learning using the data set (or a set including data selected according to the outlier detection) (S140). Thereafter, validation is performed on the trained recognition model (S150). Here, some of the data sets acquired in step S120 may be used for training, and the remaining sets may be used for validation.

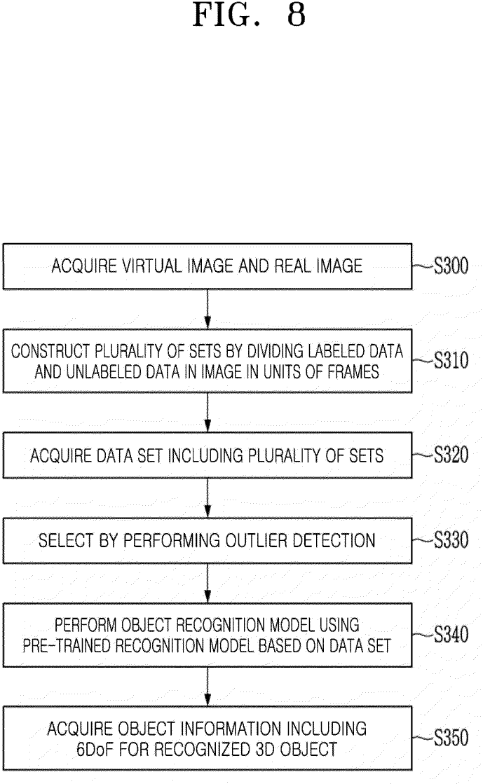

FIG. 8 is a flowchart of a method of recognizing a 3D object according to an embodiment of the present disclosure.

As illustrated in FIG. 8, a data set for object recognition is generated. Then, the object information on the 3D object is acquired using the pre-trained object recognition model.

To this end, a virtual image that is video data is acquired, and a real image is acquired (S300). The virtual image and the real image may be labeled data or unlabeled data.

In an embodiment of the present disclosure, self-supervised learning is performed after constructing a data set using only a small number of pieces of labeled data. To this end, a plurality of sets are formed by dividing labeled data (including the virtual image and the real image) and unlabeled data (including the virtual image and the real image) into a set number of frames (S310). Each set includes one (first set number) piece of labeled data composed of the set number of frames, and a plurality (second set number) of pieces of unlabeled data composed of the set number of frames. A data set including the sets is constructed (S320).

Here, by performing outlier detection on the data set, it is possible to select video data whose outlier detection result satisfies a set condition (S330). For example, by performing the outlier detection on the labeled data and/or unlabeled data of the data set, it is possible to select data having many outliers. This operation may optionally be performed. Data satisfying the set condition may be selected while the outlier detection is performed only on the unlabeled data.

Then, the object recognition is performed by inputting the data set (or the set including data selected according to the outlier detection) to the pre-trained recognition model (recognition model trained and validated based on self-supervised learning according to the method of FIG. 7) (S340). In this case, object recognition may be performed while querying labeling in units of frames.

Thereafter, labeling for the recognized object, that is, object information, is acquired (S350). The object information includes the 6DoF of a recognized 3D object, and may further include at least one of a distance to a center point and shape information.

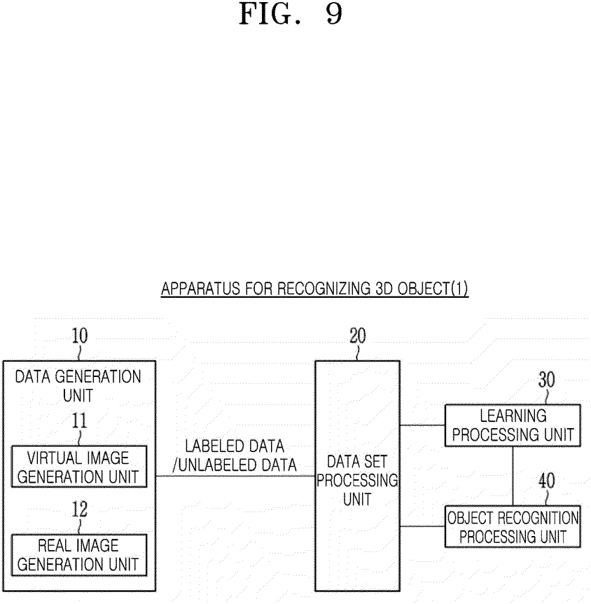

FIG. 9 is a diagram illustrating a structure of an apparatus for recognizing a 3D object based on deep learning according to an embodiment of the present disclosure.

As illustrated in FIG. 9, an apparatus 1 for recognizing a 3D object according to the embodiment of the present disclosure includes a data generation unit 10, a data set processing unit 20, a learning processing unit 30, and an object recognition processing unit 40.

The data generation unit 10 includes a virtual image generation unit 11 and a real image generation unit 12. The virtual image generation unit 11 is configured to generate or collect virtual images of 3D virtual objects in a virtual environment. The real image generation unit 12 is configured to generate or collect real images of 3D objects in a real environment. The virtual images and real images may be video data composed of frames. Also, the virtual image and the real image may be labeled data or unlabeled data. Accordingly, the image data (virtual image and real image), that is, the labeled data and the unlabeled data, is obtained by the data generation unit 10.

The data set processing unit 20 constructs a data set based on the labeled data and the unlabeled data which are virtual images and real images. Specifically, the data set processing unit 20 constructs a plurality of sets by dividing the labeled data and the unlabeled data into a set number of frames, and constructs a data set including the plurality of sets. Each set includes a first set number of pieces of labeled data composed of a set number of frames, and a second set number of pieces of unlabeled data composed of the set number of frames. Here, the first set number may be “1,” and the second set number may be an integer greater than or equal to 2.

In addition, the data set processing unit 20 may be configured to perform outlier detection on these data sets and select data whose outlier detection result satisfies a set condition.

This data set processing unit 20 may also be referred to as an “active learning engine.”

The learning processing unit 30 is configured to train a recognition model based on self-supervised learning using a data set (or a set including data selected according to the outlier detection) transmitted from the data set processing unit 20. In addition, the learning processing unit 30 is configured to perform validation on the trained recognition model.

The objection recognition processing unit 40 is configured to apply the data set (or the set including the data selected according to the outlier detection) transmitted from the data set processing unit 20 to the pre-trained recognition model provided from the learning processing unit 30 in order to perform object recognition. In this case, the object recognition may be performed while querying labeling in units of frames. Thereafter, object information on the recognized object is acquired, and the object information includes the 6DoF of a recognized 3D object, and may further include at least one of a distance to the center point and the shape information.

Since each of these components 10 to 40 is configured to implement the corresponding method described above, the above description may be referred to for specific functions.

According to an embodiment of the present disclosure, computer vision deep learning technology can be improved by removing/reducing the need for labeling in self-supervised learning, and more efficient model learning can be performed through the self-supervised learning rather than the supervised learning that requires a vast amount of labeling.

The apparatus and method according to these embodiments can be applied to robot control-based factory automation, so cost can be reduced and inefficient internal processes can be removed in factory automation, and productivity can be improved. In addition, real-time inspection is possible during the robot-based manufacturing process by achieving over 90% accuracy in a model that predicts and generates the 3D information of the object by itself.

In particular, according to an embodiment of the present disclosure, by extracting and analyzing 3D information according to the self-supervised learning, it is possible to significantly improve productivity and automation at manufacturing sites. Therefore, the method and apparatus of the present disclosure are expected to play a key role in building an intelligent autonomous factory system based on accurate 3D object recognition and information extraction.

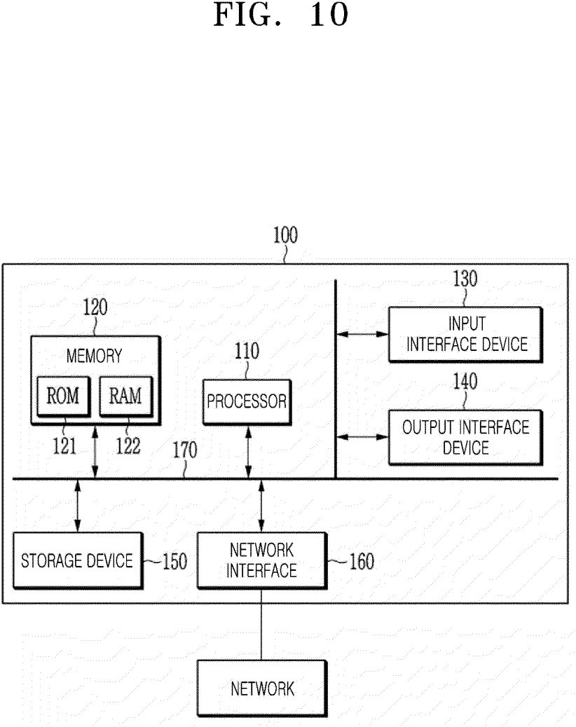

FIG. 10 is a structural diagram for describing a computing device for implementing the method according to the embodiment of the present disclosure.

As illustrated in FIG. 10, the method according to the embodiment of the present disclosure may be implemented using a computing device 100.

The computing device 100 may include at least one of a processor 110, a memory 120, an input interface device 130, an output interface device 140, a storage device 150, and a network interface device 160. Each component may be connected by a bus 170 to communicate with each other. In addition, each of the components may be connected through individual interfaces or individual buses centering on the processor 110 instead of a common bus 170.

The processor 110 may be implemented in any of various types such as an application processor (AP), a central processing unit (CPU), a graphics processing unit (GPU), and the like, and may be any semiconductor device that executes commands stored in the memory 120 or the storage device 150. The processor 110 may execute program commands stored in at least one of the memory 120 and the storage device 150. Such a processor 110 may be configured to implement the functions and methods described above based on FIGS. 1 to 9. For example, the processor 110 may be implemented to perform functions of a data set processing unit, a learning processing unit, and an object recognition processing unit. Also, the processor 110 may additionally be implemented to perform a function of a data generation unit, which may be optionally implemented. When the processor 110 does not perform a function of a data generation unit, the processor 110 may receive data to construct a data set from the input interface device 130 or network interface device 160, that is, labeled data corresponding to virtual images and real images, and unlabeled data corresponding to virtual images and real images.

The memory 120 and the storage device 150 may include various types of volatile or non-volatile storage media. For example, the memory may include a read only memory (ROM) 121 and a random access memory (RAM) 122. In an embodiment of the present disclosure, the memory 120 may be located inside or outside the processor 110, and the memory 120 may be connected to the processor 110 through various known means.

The input interface device 130 is configured to provide data to the processor 110, and the output interface device 140 is configured to output data (object information or the like) from the processor 110.

The network interface device 160 may transmit or receive a signal to or from other devices (e.g., robot) through a wired network or a wireless network.

The input interface device 130, the output interface device 140, and the network interface device 160 may be collectively referred to as an “interface device.”

The computing device 100 having such a structure is referred to as an apparatus for recognizing a 3D object, and may implement the above methods according to the embodiments of the present disclosure.

In addition, at least some of the methods according to the embodiment of the present disclosure may be implemented as a program or software executed on the computing device 100, and the program or software may be stored in a computer-readable medium.

In addition, at least some of the methods according to the embodiment of the present disclosure may be implemented as hardware that may be electrically connected to the computing device 100.

Embodiments of the present disclosure are not implemented only through the above-described devices and/or methods, and may be implemented through a program that realizes functions corresponding to the configuration of the embodiments of the present disclosure or a recording medium on which the program is recorded. Such implementation can be easily implemented by those skilled in the art to which the present disclosure pertains based on the description of the above-described embodiment.

According to embodiments, in deep learning machine vision image analysis, it is possible to accurately recognize a 3D object by improving analysis performance. In addition, since information including 6DoF information and a distance to a center point of a 3D object can be acquired, it is possible to identify even cosmetic and functional abnormalities that are difficult to deal with in the existing machine vision based on deep learning-based image analysis and accurately recognize the 3D object and effectively apply the recognized 3D object to a robot-based factory automation process.

In addition, by using unlabeled data for a data set required to train a machine learning model for recognizing a 3D object, it is possible to reduce the cost of acquiring a large labeled data set, reduce human labor time for labeling, and automatically generate a label to more efficiently perform machine learning. Therefore, compared to artificial intelligence based on supervised learning through the existing labeled data, it is possible to implement access to more diverse fields and utilization of data. In addition, it is possible to remove/reduce the need for labeling in self-supervised learning to improve computer vision deep learning techniques.

In addition, by forming a data set for learning and validation using virtual synthetic data and data of a real physical environment, it is possible to improve machine learning performance and reduce the time required for data set generation. In particular, it is possible to provide a vast amount of high-quality data and provide data scalability.

In addition, by applying the method and apparatus for recognizing a 3D object to the robot-based factory automation process, it is possible to further improve the efficiency of factory automation.

Although embodiments of the present disclosure have been described in detail hereinabove, the scope of the present disclosure is not limited thereto, and may include several modifications and alterations made by those skilled in the art using the basic concepts of the present disclosure as defined in the claims.

What is claimed is:

1. A method of recognizing a three-dimensional (3D) object, comprising:
constructing, by an object recognition apparatus, a data set including a virtual image and a real image, the data set including labeled data corresponding to the virtual image and the real image, and unlabeled data corresponding to the virtual image and the real image;
performing, by the object recognition device, object recognition by inputting the data set to a recognition model for object recognition pre-trained based on self-supervised learning; and
acquiring, by the object recognition apparatus, object information according to the object recognition using the recognition model.

2. The method of claim 1, wherein the data set includes a plurality of sets, each set including a first set number of pieces of labeled data composed of a set number of frames, and a second set number of pieces of unlabeled data composed of the set number of frames.

3. The method of claim 2, wherein the first set number is “1,” and the second set number is an integer greater than or equal to 2.

4. The method of claim 1, wherein the object information includes six degrees of freedom (6DoF) of the object, and further includes at least one of a distance to a center point and shape information.

5. The method of claim 1, wherein the constructing of the data set includes:
performing outlier detection on data included in the data set; and
constructing the data set by selecting data for which a result of the outlier detection satisfies a set condition from among data included in the data set.

6. The method of claim 5, wherein, in the performing of the outlier detection, the outlier detection is performed on the unlabeled data in the data set; and
in the constructing of the data set by selecting only data for which the result of the outlier detection satisfies the set condition from among the unlabeled data is selected as data for performing the object recognition.

7. The method of claim 1, wherein, in the performing of the object recognition, the object recognition is performed by querying labeling of the data included in the data set in units of frames.

8. A method of recognizing a three-dimensional (3D) object, comprising:
constructing, by an object recognition apparatus, a data set including a virtual image and a real image, the data set including labeled data corresponding to the virtual image and the real image, and unlabeled data corresponding to the virtual image and the real image; and
training, by the object recognition apparatus, a recognition model for object recognition using self-supervised learning based on the data set.

9. The method of claim 8, wherein the data set includes a plurality of sets, each set including a first set number of pieces of labeled data composed of a set number of frames, and a second set number of pieces of unlabeled data composed of the set number of frames.

10. The method of claim 9, wherein the first set number is “1,” and the second set number is an integer greater than or equal to 2.

11. The method of claim 8, wherein the constructing of the data set includes:
performing outlier detection on data included in the data set; and
constructing the data set by selecting data for which a result of the outlier detection satisfies a set condition from among data included in the data set.

12. The method of claim 11, wherein, in the constructing of the data set, a higher priority is given to unlabeled data, in which a difference between a result of performing inference without performing the outlier detection and a result of performing the inference after performing the outlier detection is greater than a set value, over other pieces of data, and the unlabeled data is included in the data set.

13. An apparatus for recognizing a three-dimensional (3D) object, comprising:
an interface device; and
a processor connected to the interface device to perform object recognition,
wherein the processor includes:
a data set processing unit configured to construct a data set including a virtual image and a real image, the data set including labeled data corresponding to the virtual image and the real image, and unlabeled data corresponding to the virtual image and the real image; and
an object recognition processing unit configured to input the data set to a recognition model for pre-trained object recognition based on self-supervised learning to perform the object recognition and acquire object information.

14. The apparatus of claim 13, wherein the data set includes a plurality of sets, each set including a first set number of pieces of labeled data composed of a set number of frames, and a second set number of pieces of unlabeled data composed of the set number of frames.

15. The apparatus of claim 14, wherein the first set number is “1,” and the second set number is an integer greater than or equal to 2.

16. The apparatus of claim 13, wherein the object information includes six degrees of freedom (6DoF) of the object, and further includes at least one of a distance to a center point and shape information.

17. The apparatus of claim 13, wherein the data set processing unit is configured to construct the data set by performing outlier detection on data included in the data set and selecting data for which a result of the outlier detection satisfies a set condition from among the data included in the data set.

18. The apparatus of claim 13, wherein the data set processing unit is configured to perform outlier detection on the unlabeled data in the data set, and select only data for which the result of the outlier detection satisfies a set condition from among the unlabeled data and select the selected data as data for performing the object recognition.

19. The apparatus of claim 13, wherein the processor further includes a training processing unit configured to train the recognition model for the object recognition using self-supervised learning based on the data set.

20. The apparatus of claim 19, wherein the training processing unit gives a higher priority to unlabeled data in which a difference between a result of performing inference without performing outlier detection and a result of performing the inference after performing the outlier detection is greater than a set value, over other pieces of data, and include the unlabeled data in the data set.
